(19) United States
(12) Patent Application Publication
(10) Pub. No.: US 2015/0342209 A1
(43) Pub. Date: Dec. 3, 2015

(54) COMPOSITE DAIRY DESSERT AND ITS PROCESS OF PREPARATION

(71) Applicant: NESTEC S.A., Vevey (CH)

(72) Inventors: Theodora Panagiotou, Caen (FR); Marie-Line Cauneille, Cheffreville Tonnencourt (FR); Jean Moreau, Manerbe (FR)

(21) Appl. No.: 14/654,001

(22) PCT Filed: Dec. 19, 2013
(86) PCT No.: PCT/EP2013/077510

§ 371 Date: Jun. 19, 2015

(30) Foreign Application Priority Data
Dec. 19, 2012 (EP) 12198238.3

(51) Int. Cl. A23C 9/154

(52) U.S. Cl. CPC A23C 9/1544

(57) ABSTRACT

A composite dessert having neutral pH is disclosed, as well as a process for preparing the dessert. The composite dessert comprises an outer phase and an inner phase, where compositions of the outer phase and of the inner phase have similar densities and different viscosities, gel strengths and sensory attributes.

### TECHNICAL FIELD

The invention relates to a composite dairy dessert, such as desserts comprising an outer phase and an inner phase. The invention also relates to a process for manufacturing said dairy dessert, where an outer phase and an inner phase are dosed successively into the same container, while keeping the outer phase and inner phase separate from each other in the final product.

### BACKGROUND OF THE INVENTION

Any reference to prior art documents in this specification is not to be considered an admission that such prior art is widely known or forms part of the common general knowledge in the field.

Composite desserts are known, where at least two different layers are superimposed in a pot. One layer can comprise, for instance, a milk-based component, such as custard cream or yoghurt, or fromage frais, while another one is a jellified neutral dairy composition, based for instance on chocolate, caramel or cream. A third layer may include a mousse, or a whipped cream.

A composite dessert comprising at least one milk-based inclusion disposed into a jellified composition that is preferably translucent or transparent and has an acidic pH is disclosed in WO2010/020576. Said dessert is obtained by a process where a mix of fruit juice is prepared and heated to about 70° C., thickened with carrageenan and guar gum and cooled to about 30-40° C. before filling into a container. A milk composition is homogenized at 70° C. and fermented, and then injected into the thickened juice mix which has been dosed before in the pot, at a temperature of 30 to 45° C. This creates an inclusion of milk composition into the jellified juice, where the inclusion of milk composition represents about 10 to 30% of the volume of the final product.

EP 0381806 A1 describes a process for the production of jellied food having cream-like inclusion. The inclusion is added in the frozen state to the dosed jelly in liquid state. A film of set jelly forms around the inclusion. Thereafter, the container is sealed and subjected to heat sterilization process. JP H06-181733 A discloses a similar process where a frozen piece is embedded in an unsolidified gellable product. The gellable product is then submitted to gelling.

There remains a need for new types of composite desserts, which display new sensory attributes, such as the combination of different tastes and/or textures.

Also, though preparing a composite dessert where both the outer phase and the inner phase have thick textures can be performed with existing techniques, there also remains a need for a process which is conveniently applicable to the industrial scale, and which allows combining components having different physicochemical properties (viscosity, gel strength etc.) while ensuring they do not mix during the preparation of the final product.

The invention thus aims at providing a neutral dairy composite dessert comprising an outer phase and an inner phase, which provides innovative organoleptic properties, based for example on its texture, its taste, or on contrasts of texture or taste. The invention also aims at providing a process for preparing this neutral dairy composite dessert which allows the outer phase and the inner phase, which have different viscosities and gel strengths, to be dosed simultaneously in the same container at different temperatures, while preventing the inner phase from transferring into the outer phase.

### SUMMARY OF THE INVENTION

In a first aspect of the invention, there is provided a process for manufacturing a composite dairy dessert having a neutral pH, comprising the steps of:
preparing a first composition and a second composition, where the first and second compositions have similar densities, and where the viscosity of the first composition at its dosing temperature is lower than the viscosity of the second composition at its dosing temperature,
dosing the first composition in a liquid state, at a temperature of from 50° C. to 80° C., into a container
dosing the second composition into said container, at a temperature of from 4° C. to 30° C., without mixing, before setting of the first composition,
then cooling, to allow setting of the first composition as an outer phase enclosing at least partially an inner phase constituted of said second composition.

The first composition is dosed in a liquid state with low viscosity into the container. The second composition is dosed as a highly viscous liquid. Controlling viscosities and densities of the first and second compositions, at the dosing temperature, makes it possible to obtain the desired structure of the composite dessert, where the inner phase and outer phase do not get mixed together. In other words, there is a visible separation between the inner phase and the outer phase.

In a preferred embodiment, the first composition, or outer phase composition, is dosed in the container at a temperature of from 60° C. to 75° C.

According to another preferred embodiment, the second composition, or inner phase composition, is dosed at a temperature of from 4° C. to 15° C., into the container which already contains the first composition, before setting of the first composition.

In a second aspect of the invention, there is provided a dairy composite dessert having neutral pH, where the outer phase composition and the inner phase composition have similar densities. Preferably, the outer phase is a gelled phase, and the inner phase is a cream custard phase.

### DETAILED DESCRIPTION

The invention provides a process for preparing a dairy composite dessert having neutral pH comprising an outer phase made of a first composition, and an inner phase made of a second composition, where the first and second compositions have different viscosities, gel strengths and sensory attributes, while having similar densities.

The process according to the invention relies on an appropriate combination of parameters, such as, for instance, temperature, density and viscosity of the first composition and second composition.

As used in this specification, the words “comprises”, “comprising”, and similar words, are not to be interpreted in an exclusive or exhaustive sense. In other words, they are intended to mean “including, but not limited to”.

“Neutral pH” as used herein means a pH value in the range of 6.3 to 7.2, preferably from 6.5 to 7.0. If needed, pH adjustment can be carried out by usual means, such as addition of an acid or a base. Preferably, neutral relates to the flavor of the final product, which is not perceived as acidic.

“Outer phase” as used herein is understood as the part of the composite dessert which is made from the first composition, or “outer phase composition” and which surrounds the inner phase. The outer phase constitutes the major part of the composite dessert, preferably 70% to 80% of the final product volume. Preferably, the outer phase is a gelled phase, once it has reached chilled temperatures suitable for storing.

The outer phase composition has a low viscosity, namely it is in a fluid state, at the selected dosing temperature. In a preferred embodiment of the invention, the outer phase composition has a viscosity of between 50 mPa·s and 200 mPa·s at the dosing temperature, preferably at a temperature of from 50° C. to 80° C., and more preferably at a temperature of 60° C. to 75° C. In other words, the first composition, or outer phase composition, is liquid at dosing temperature.

“Inner phase” as used herein means the part of the dessert which is made from the second composition, or “inner phase composition”, and which is surrounded by the outer phase. Preferably, the inner phase cannot be seen from the top of the final product, after setting. In other words, the inner phase has no contact with the ambient air. Except if the container is transparent, the inner phase cannot be seen from the outside of the container. If the container is transparent, in some embodiments, the inner phase can be seen from the bottom of the container. The inner phase constitutes the minor part of the composite dessert, preferably 20% to 30% of the final product volume.

The inner phase composition has a high viscosity, namely it is not in a fluid state, at the selected dosing temperature, which makes it possible to dose the inner phase composition in the container containing the outer phase composition without leading to the mixing of the inner phase composition into the outer phase composition. At dosing temperature, the inner phase remains pumpable, which allows dosing into the container. Preferably, the inner phase composition has a viscosity of between 15000 mPa·s and 30000 mPa·s at dosing temperature, preferable at a temperature of from 4° C. to 30° C., and even more preferably at a temperature of from 4° C. and 15° C.

Viscosity of the first composition and second composition can be measured by using a Brookfield viscometer. The viscosity of the first composition (outer phase) is measured with Brookfield viscometer plate module 02 with a rotating speed of 50 rpm at 55-65° C. The viscosity of the second composition (inner phase) is measured with a Brookfield viscometer T bar module of 92, with a rotating speed of 5 rpm at 10-15° C.

“Similar densities” is understood as having a difference in the densities which does not exceed 15%, preferably that a difference that does not exceed 10%, and more preferably, that does not exceed 5%. In a preferred embodiment, the densities of the inner phase composition and of the outer phase composition are identical. Preferably, the inner phase composition and the outer phase composition have densities in the range of 0.95 to 1.10, preferably in the range of 1.0 to 1.10. More preferably, the inner phase composition and the outer phase composition have densities in the range of 1.05 to 1.09, and even more preferably in the range of 1.06 to 1.09. This density range is interesting because it is appropriate for making low fat products, with the desired contrast of textures between the inner phase and the outer phase, which the consumers are interested in. Preparing compositions with lower densities would involve increasing the fat content, or increasing the water content. This would not be compatible with maintaining an appropriate texture for the final product. On the other hand, preparing compositions with higher densities would involve increasing the sugar content for instance, which is incompatible with a product having a low caloric profile. There are other options to increase or reduce the density of the inner phase composition and the outer phase composition, but they impact the texture of the respective phase in an undesirable manner.

The density of the first and second compositions is measured with an Anton-Paar DMA 38 densimeter, at a temperature between 15° C. and 40° C. Density is the ratio between the volumic mass of the composition and the volumic mass of water, at the same temperature.

Controlling the respective densities of the outer phase and of the inner phase is all the more advantageous with respect to the manufacturing process that dosing can thus be performed easily on the manufacturing line by controlling the temperature without additional process steps.

The outer phase composition (first composition) and the inner phase composition (second composition) comprise a milk based component. By “milk-based component” is meant at least one component selected from whole milk, skimmed milk or partially skimmed milk, optionally reconstituted from milk powder, dairy cream, anhydrous milk fat, milk protein powder, and their mixtures. Dairy fat may be a component of the milk-based component, or can be added, partially or totally, thereto.

The outer phase composition may also contain one or more gelling agent(s), such as, for example, galactomannans, carrageenans, xanthan gum, gelatin, starches and/or alginate.

In a preferred embodiment, the first composition comprises 70% to 90% of a milk-based component and 0.5% to 3% of gelling agent(s), expressed in weight % of the first composition (including water content).

The inner phase composition may contain one or more thickening agents, such as, for example, guar gum, locust bean gum, pectins, xanthan gum, starch and their mixtures.

In a preferred embodiment, the inner phase composition comprises 60% to 90% of a milk-based component and 0.5 to 6% of thickening agent(s), expressed in weight % of the second composition (including water content).

The outer phase and inner phase compositions may also contain usual ingredients of dairy dessert compositions such as carbohydrates, in particular sucrose, fructose or a natural sweetening extracts such as stevia, and their mixtures; vegetal ingredients, such as cocoa, vegetable fat (cocoa butter, coconut oil, sunflower oil, rapeseed oil; natural or artificial coloring agents; natural or artificial flavoring agents; sweeteners, in particular artificial sweeteners such as acesulfame, sodium cyclamate, neohesperidine and their mixtures.

In a preferred embodiment, the outer phase and inner phase compositions are preferably light in fat and/or sugar contents. In particular, the final composite dessert contains no more than 1.2 fat weight % and/or no more than 3 sugar weight %. In other words, the composite dessert contains less than 1.2% by weight of fat, or less than 3% by weight of sugar, or less than 1.2% by weight of fat and less than 3% by weight of sugar.

The process according to the invention can be performed by separately preparing the first composition and the second composition, for example by carrying out the following steps: 1) mixing all the ingredients at cold temperature, for example 10° C. to 15° C., and low speed, 2) adjusting the pH to a neutral value, for example 6.5 to 7.0, and 3) performing usual powder hydration, pre-heating, homogenization, sterilization, cooling and storage steps.

This is only an example of a method of preparation of the first and second compositions. Preparation of the first and second composition could also be performed at higher temperatures.

According to a preferred embodiment, the first composition is stored at a temperature of 50° C. to 80° C., and then dosed into a container at a temperature in the range of 50° C. to 80° C., preferably 60° C. to 75° C. At the dosing temperature, the first composition is liquid: it has a low viscosity, as explained above. It is important that the first composition is dosed at a temperature above its gelling temperature.

Preferably, the second composition is stored at a temperature of 4° C. to 30° C., and then dosed into the container containing the outer phase at a temperature in the range of 4° C. to 30° C., more preferably 4° C. to 15° C. At dosing temperature, the second composition has a higher viscosity than the first composition, as explained above.

Because the second composition has a different viscosity to that of the first composition, the two compositions do not mix together, and an interface between the resulting outer phase and inner phase can be observed. Advantageously, the low dosing temperature of the second composition together with the cooled storage make the first composition set around the first composition, thus providing the composite structure of the dessert with an inner phase and an outer phase. Indeed, when the second composition is dosed at, for instance, 4° C., into the first composition at, for instance, 65° C., the first composition can cool down to 55° C., depending on the respective volumes.

After dosing of the first and second compositions, the container is cooled, which allows setting of the first composition as an outer phase enclosing at least partially an inner phase constituted of said second composition. Preferably, the first composition, or outer phase composition, sets at a temperature in the range of 25° C. to 45° C., preferably in the range of 30° C. to 40° C. The setting temperature depends on the gelling agent(s) contained in the first composition. Setting temperatures are known parameters of the gelling agent(s).

In more details, dosing of the first and second compositions can be achieved simultaneously or successively. Simultaneous dosing of the first and second compositions can be achieved through two dispensers and a unique nozzle at a single dosing station. This is known as co-dosing. Co-dosing requires synchronization and fine control of the two dispensers.

Successive dosing uses two dispensers each with its independent dosing nozzle. Dosing of the second compositions occurs immediately after dosing of the first composition. This process is simpler than co-dosing.

It is important to control the speed (force) of dosing of the second composition, to avoid the second composition going too low into the container, or conversely to avoid that the second composition fills the container too superficially on the top. As the densities of the inner and outer compositions are similar, the filling process imparts enough speed to the second composition to ensure it is placed in the center of the container during dosing.

To achieve this, several parameters can be considered and adapted. The speed of dosing depends on the diameter of the nozzle and on the height of drop. For instance, the dosing nozzle is placed fixed above the cup (no product contact). After reasonably adjusting the dosing speed, the nozzle height is adjusted in order to adjust the height of drop of the second composition, to place the second composition at the center of the container. Because the first and second compositions have similar densities, the second composition will remain at the position where it is placed.

It is also interesting to observe that once the inner phase is placed into the outer phase, the product is not distorted by the inevitable shocks that happen immediately after dosing on an industrial line. The inner phase is kept in stable suspension in the surrounding outer phase.

The invention further relates to a dairy composite dessert having neutral pH, obtainable by the process described above. The dairy composite dessert comprises two phases, namely an outer phase and an inner phase.

Preferably, in the dairy composite dessert of the invention, the outer phase composition represents 70% to 80% of the volume, and the inner phase composition represents 20% to 30% of the volume of the dairy composite dessert. The volume percent are indicative.

The outer phase composition and an inner phase have similar densities, as described above with respect to the process. Preferably, the inner phase composition and the outer phase composition have densities in the range of 0.95 to 1.10, preferably in the range of 1.0 to 1.10. More preferably, the inner phase composition and the outer phase composition have densities in the range of 1.05 to 1.09, and even more preferably in the range of 1.06 to 1.09. This density range is interesting because it is appropriate for making low fat products, with the desired contrast of textures between the inner phase and the outer phase, which the consumers are interested in.

As described above with respect to the process, the outer phase composition has a viscosity of between 50 mPa·s and 200 mPa·s at a temperature of from 50° C. to 80° C., and the inner phase composition has a viscosity of between 15000 mPa·s and 30000 mPa·s at a temperature of from 4° C. to 30° C. The viscosity of the first composition and second composition can be measured by using a Brookfield viscometer. The viscosity of the first composition (outer phase) is measured with Brookfield viscometer plate module 02 with a rotating speed of 50 rpm at 55-65° C. The viscosity of the second composition (inner phase) is measured with a Brookfield viscometer T bar module of 92, with a rotating speed of 5 rpm at 10-15° C.

In a preferred embodiment, the outer phase composition comprises 70% to 90% of a milk-based component and 0.5% to 3% of thickening and/or gelling agent(s), expressed in weight % of the first composition (or outer phase composition).

According to another embodiment, the inner phase composition comprises 60% to 90% of a milk-based component and 0.5% to 6% of thickening agent(s), expressed in weight % of the second composition (or inner phase composition).

In an embodiment, the dairy composite dessert is low fat, low sugar, or low fat and low sugar. In other words, the dairy composite dessert contains less than 1.2% by weight of fat, or less than 3% by weight of sugar, or less than 1.2% by weight of fat and less than 3% by weight of sugar. In another embodiment, the dairy composite dessert is full fat.

Depending on the desired effect, the inner phase may be positioned at different positions within the outer phase, relative to the height of the container. The positioning of the inner phase depends for instance, as explained above, on the speed of dosing, the diameter of the nozzle, or the height of drop.

Hence, the inner phase may be positioned at or close to the bottom of the container.

Alternatively, the inner phase may be positioned close to the surface of the outer layer. Further alternatively, the inner phase may be positioned at an intermediate position between the bottom of the container and the surface of the outer layer. The inner phase is not a layer that extends radially from axis of the container to the outer wall of the container. Preferably, the inner phase does not reach the outer wall of the container. This way, the inner phase remains hidden within the outer phase. This offers a surprising and fun effect to the consumer upon consumption, for instance due to the difference of texture, of aroma, or of color. Preferably, the inner phase has the overall shape of a drop embedded within the outer phase.

The container can be a standard container in plastic or in glass, suitable for chilled dairy products. Usually, several containers are packed together.

With respect to the consumer's expectations, the invention provides a new type of dairy composite dessert, which makes it possible to combine different textures, such as an outer phase having a melt-in-the-mouth gel texture and an inner phase having a spoonable texture, or else. For instance, the first composition, which yields the outer phase, is a milk-based gel, with a flavor such as chocolate, vanilla, caramel, pistachio, and hazelnut. For instance, the second composition, which yields the inner phase, is a milk-based custard cream, with chocolate, vanilla, caramel, pistachio, hazelnut, fruit, orange, mint, berries.

Also, the neutral dairy composite dessert according to the invention advantageously provides a combination of “spoonable” and clean cut gel structure. It means that when the consumer plunges a spoon, or another tool used for eating, into the dessert, the spoon leaves an empty space into the outer phase which makes the inside of the dessert appear, while the inner phase may flow. Preferably, the outer phase is a gel, while the inner phase is a custard cream type composition.

In addition to the inner phase and outer phase, the dairy composite dessert may comprise a topping, such a low-fat cream or Chantilly, fruit syrup or fruit jelly, or pieces of confectionery products, such as caramel, roasted nuts.

The invention is further described with reference to the following examples. It will be appreciated that the invention as claimed is not intended to be limited in any way by these examples.

### Example 1

### Composite Dairy Product with Chocolate Outer Phase and Vanilla Inner Phase

| Chocolate outer phase | Wt % | Vanilla inner phase | Wt % |
|---|---|---|---|
| Fresh and powder | 87.6 | Fresh and powder skimmed milk | 88.2 |
| skimmed milk | | | |
| Cream 34% fat | 2.1 | Cream 34% fat | 5.0 |
| Sugar | 3.0 | Sugar | 3.0 |
| Starch | 1.7 | Starch | 3.5 |
| Inuline powder | 2.8 | Carrageenan | 0.2 |
| Carrageenan | 0.6 | Flavour | 0.1 |
| Cacao | 2.0 | | 100.0 |
| Flavour | 0.2 | | |
| | 100.0 | | |

The chocolate outer phase is mixed at 10-20° C., homogenized at 50bars at 60° C., sterilized at 130° C. and dosed at 75° C. The vanilla inner phase follows the same process with the exception that it is cooled down to 15° C. for the dosing.

The two phases are dosed one after the other from two separate and fixed nozzles.

The densities of the two compositions are similar and equal to 1.07. The chocolate composition has a viscosity of 130 mPa·s at dosing temperature. The vanilla cream custard has a viscosity of 10'000 mPa·s at dosing temperature.

The composite dairy product comprises 75% of chocolate outer phase and 25% of vanilla inner phase.

### Example 2

### Composite Dairy Product with Pistachio Outer Phase and Chocolate Inner Phase

| Pistachio outer phase | Wt % | Chocolate inner phase | Wt % |
|---|---|---|---|
| Fresh full fat milk | 81.6 | Fresh full fat milk | 81.2 |
| Skimmed milk powder | 4.0 | Skimmed milk powder | 4.0 |
| Dairy cream 35% fat | 3.0 | Dairy cream 35% fat | 3.0 |
| Sugar | 10.0 | Sugar | 8.0 |
| Locust bean gum | 0.5 | Starch | 3.5 |
| Colorant | 0.1 | Agar agar | 0.2 |
| Guar gum | 0.7 | Flavour | 0.1 |
| Flavour | 0.1 | | 100.0 |
| | 100.0 | | |

The inner and outer phases are prepared in a similar fashion as in Example 1. Dosing of the two phases is performed at 75° C. and 15° C. for the outer phase and the inner phase respectively. The densities of the two compositions are similar and equal to 1.07.

The composite dairy product comprises 70% of pistachio in the outer phase and 30% of vanilla in the inner phase.

1. A process for manufacturing a composite dairy dessert having a neutral pH, comprising the steps of:
preparing a first composition and a second composition, where the first and second compositions have similar densities, and where the viscosity of the first composition at its dosing temperature is lower than the viscosity of the second composition at its dosing temperature,
dosing the first composition in a liquid state, at a temperature of from 50° C. to 80° C., into a container
dosing the second composition into said container, at a temperature of from 4° C. to 30° C., without mixing, before setting of the first composition,
then cooling, to allow setting of the first composition as an outer phase enclosing at least partially an inner phase constituted of said second composition.

2. The process according to claim 1, where the first composition is dosed into the container at a temperature of from 60° C. to 75° C.

3. The process according to claim 1 or 2, where the second composition is dosed at a temperature of from 4° C. to 15° C., into the container which already contains the first composition.

4. The process according to any one of claims 1 to 3, where the first composition has a viscosity of between 50 mPa·s and 200 mPa·s at dosing temperature.

5. The process according to any one of claims 1 to 4, where the second composition has a viscosity of between 15000 mPa·s and 30000 mPa·s at dosing temperature.

6. The process according to any one of claims 1 to 5, where the first composition and the second composition have densities in the range of 0.95 to 1.10.

7. The process according to any one of claims 1 to 6, where the first composition comprises 70% to 90% of a milk-based component and 0.5% to 3% of gelling agents, expressed in weight % of the first composition.

8. The process according to any one of claims 1 to 7, where the second composition comprises 60%to 90% of a milk-based component and 0.5% to 6% of thickening agents, expressed in weight % of the second composition.

9. A dairy composite dessert having neutral pH, obtainable by the process according to any one of claims 1 to 8.

10. A dairy composite dessert according to claim 9, where the outer phase composition and the inner phase composition have similar densities.

11. A dairy composite dessert according to claim 9 or 10, where the outer phase composition represents 70% to 80% of the volume, and the inner phase composition represents 20% to 30% of the volume.

12. A dairy composite dessert according to any one of claims 9 to 11, where the first composition comprises 70% to 90% of a milk-based component and 0.5% to 3% of gelling agents, expressed in weight % of the first composition.

13. A dairy composite dessert according to any one of claims 9 to 12, where the second composition comprises 60%to 90% of a milk-based component and 0.5% to 6% of thickening agents, expressed in weight % of the second composition.

14. A dairy composite dessert according to any one of claims 9 to 13, which contains less than 1.2% by weight of fat, or less than 3% by weight of sugar, or less than 1.2% by weight of fat and less than 3% by weight of sugar.

15. A dairy composite dessert according to any one of claims 9 to 14, wherein, said outer phase is a gelled phase.
